(19) United States
(12) Patent Application Publication
(10) Pub. No.: US 2011/0230616 A1
(43) Pub. Date: Sep. 22, 2011

(54) WATER REDUCIBLE ALKYD RESINS

(76) Inventors: Sidhartha Bhimania, New Delhi (IN); Krishna Gopal Singh, New Delhi (IN); Sandeep Mourya, New Delhi (IN); Ashok N. Bhaskarwar, New Delhi (IN)

(21) Appl. No.: 13/059,280

(22) PCT Filed: Aug. 24, 2009
(86) PCT No.: PCT/IB09/06627

§ 371 Date: May 16, 2011

(30) Foreign Application Priority Data
Aug. 26, 2008 (IN) 2019/DEL/2008

(51) Int. Cl. C09D 11/00; C08G 63/12; C08G 63/181; C08G 63/52

(52) U.S. Cl. 524/604; 528/302; 528/301; 528/272; 528/308; 528/306

(57) ABSTRACT

The present invention provides an alkyd resin comprising of polyols, natural oil polyol and polybasic acid or its anhydrides with a high acid number and a high viscosity and molecular mass. The invention also provides a process for preparing the same thereof and ink formulation comprising the said alkyd resin.

### FIELD OF THE INVENTION

The present invention provides a novel alkyd resin comprising a polyol, natural oil polyol (castor oil) and a polybasic acid or its anhydride, the resin having high acid number, viscosity and molecular weight. This invention also provides a process for preparation of the alkyd resin. The present invention also provides ink formulation comprising of said alkyd resin.

### BACKGROUND AND PRIOR ART

Alkyd resins have been widely used in manufacturing of a variety of products including inks, paints, coatings, and the like. This is largely due to their film hardness, durability, glossiness, abrasion resistance and other characteristics.

Oil modified alkyd resins and water-borne alkyds are the major group of resins used in the surface coating industry as well as in ink formulation for printing.

Lithography printing is based upon the differences in solubility and surface wettability between an oil based component and an aqueous based component to effectively transfer the printing ink to the desired image area and prevent it from transferring to the non-image areas. Absence of stability relative to water i.e. water-insolubility of the oil based ink composition gave rise to the petroleum based ink formulation which uses petroleum based resins, as disclosed in U.S. Pat. No. 5,508,320, U.S. Pat. No. 5,173,113 which teach ink formulations having pigment, hydrocarbon or alkyd resin and mineral oil solvent.

These formulations are not eco-friendly as they emit large amounts of Volatile Organic Compounds (VOCs), during evaporation of the organic solvents into atmosphere or upon washing of such formulation in the printing machinery. The organic solvent or petroleum based resins require hydrocarbon wash solutions. Additionally, the cost of production and time consumed in preparation of these resins remained a matter of concern.

Another approach is to use vegetable oil based alkyd resins wherein vegetable oils like dehydrated castor oil, soya oil, linseed oil, rapeseed oil etc, is used as raw material. These oils do not contain hydroxyl group on their fatty acid chains. These resins are either having low viscosity or low acid numbers or both. Typically, these alkyd resins are obtained by condensation of one or more polybasic acids with one or more polyols. The polyols used for the preparation of the resin may be used directly or may be modified by, for example, partial esterification with monobasic acids before the condensation reaction. Said composition comprises low molecular weight alkyd resins.

Another approach involves preparation of resin compositions adding specific acid or hydroxyl containing compounds towards the end of the reaction. For example addition of specific acidic or hydroxyl group, containing substances such as trimellitic anhydride and trimethylol propane towards the end of the manufacturing process to provide free carboxyl groups in the resin composition, and styrenation or acrylation of the resin compositions with a monomer blend containing acidic groups. Thus, expensive chemicals are used to achieve the high acid number.

A recently published Indian application (839/DEL/2006) discloses vegetable oil based alkyd resins. This patent application teaches preparation of such resins with viscosity varying 1 to 6 PaS with acid numbers 20 to 70 mg KOH/g. Low cost product with less pollution may be an incentive to look for vegetable oil based alkyd resins. However, even the resin disclosed herein suffers from the drawbacks described above.

Thus, there remains a need for an alkyd resin which apart from being cost effective reduces the VOC emission during the process of printing and can be used with the existing infrastructure such as in printing ink formulation.

### OBJECTS OF THE INVENTION

The primary objective of the present invention is to provide the alkyd resins comprising of a polyol, natural oil polyol (castor oil) and polybasic acid or its anhydride having high acid number, high viscosity and molecular weight.

Another objective of this invention is to provide a process for preparing the said alkyd resin.

Yet another objective of this invention is to provide an ink formulation comprising said alkyd resins.

### SUMMARY OF THE INVENTION

Accordingly, the present invention provides alkyd resins using natural oil polyols (castor oil) having high viscosity, high acid number and high molecular weight, better pigment wettability, water washability in a single hybrid resin.

### DETAILED DESCRIPTION

The present invention provides a novel alkyd resin comprising a polyol, natural oil Polyol and polybasic acid and its anhydride and optionally a vegetable oil, wherein the alkyd resin has an acid number in the range of 50-150 mgKOHg⁻¹ and viscosity in the range of 400-5000 PaS.

The term polyols as used herein refers to a hydrocarbon of general formula R(OH)ₙ, wherein R is a straight chain or branched aliphatic hydrocarbon, an aromatic hydrocarbon, an alicyclic hydrocarbon or combination thereof and n is at least 2. Examples of aliphatic hydrocarbon may be such as propane, neo-pentane; aromatic hydrocarbon may be benzene and alicyclic hydrocarbon may be cyclohexane.

The polyol may be selected from any of glycerol, pentaerythritol, neo-pentyl glycol, dipentaerythritol, ethylene glycols, polyethylene glycol. Preferably the polyol is glycerol.

The amount of polyol present in the alkyd resin is in the range of 1-10% wt. Preferably, the amount of glycerol used is in the range of 5-10% wt.

The natural oil polyol as used herein are the triglycerides of fatty acids, having a general formula R″(COOH) and has at least one secondary functionality. R″ is selected from an aliphatic group with 4 to 29 carbon atoms. Secondary functionality include one or more hydroxyl groups, one or epoxy groups or one or more carboxyl groups. These are selected from ricinoleic acid, vernolic acid. Preferably natural oil polyol is castor oil.

The castor oil, a natural oil polyol, as used in the present invention differs from other commonly used polyols such as glycerol, pentaerythritol etc. In castor oil, all three hydroxyl groups are secondary hydroxyl groups (also called (β-hydroxyls). Furthermore, in Castor oil, the two hydroxyl groups are separated by 28 carbon atoms. Existing polyols like glycerol has two primary hydroxyl groups (also called α-hydroxyls) and one secondary hydroxyl group while pentaerythritol has all four as primary OH groups.

The secondary or β-hydroxyl group is less reactive than its primary or α-hydroxyls. As a result, vegetable oils/fatty acids which form unstable. β-glycerides easily get converted into α-glycerides as long as α-hydroxyls are available in the vicinity. This esterification can be controlled in the present invention, since natural oil Polyol (Castor oil) contains no primary hydroxyl group per fragment. This also aids in controlling the viscosity of an alkyd resin during the synthesis.

Furthermore, the ratio of primary OH groups from glycerol and secondary OH groups from Castor Oil is adjusted, so that the extent of the reaction and the rate of the reaction both can be controlled to produce an alkyd with high viscosities and high acid numbers.

The amount of natural oil polyol (Castor oil) used in the alkyd resin is in the range of 25-80% wt. Preferably, the amount of Castor oil is in 50-80 wt %.

The ‘polybasic acid’ as used herein refers to compounds of general formula R(COOH)ₘ, wherein R is an aliphatic group, an aromatic group, an alicyclic group, or a combination thereof, and where m is 2 or more. These may be selected from phthalic acid, maleic acid, fumaric acid, dimerized resin acids, maleic modified resin acids, fumaric modified resin acids, adipic acid, succinic acid.

Anhydrides of above mentioned acids can also be used for the preparation of resin composition such as phthalic anhydride, Maleic anhydride, trimellitic anhydride, succinic anhydrie. Preferably, polybasic anhydride is phthalic anhydride.

The amount of polybasic acid or its anhydrides used in the alkyd resin is in the range of 15-35%. Preferably, the amount of polybasic acid or its anhydride is in the range of 27-32 wt %.

The viscosity of the alkyd resin is in the range of 400 PaS-5,000 PaS. Preferably, the viscosity is in the range of 500-4000 PaS.

The acid number of the alkyd resin is in the range of 50-150 mg KOH/g resin. Preferably, the acid number is in the range of 60-100 mg KOH/g.

The applicant after intensive research and studies has found that there is an, intricate relationship between viscosity and acid number of the alkyd resin which eventually has a bearing on the final properties of alkyl resin product and the ink formulation based thereon. Based on this finding the applicant proposes in the present application a novel alkyd resin having high acid number and high viscosity as described above. It is further found that the VOC emissions during application of ink formulation based on such an alkyd resin is far less as compared to the currently used ink compositions.

TABLE 1
showing the Properties of the alkyd resin and also comparison with existing resin

| | | Acid | |
|---|---|---|---|
| Sample | | Number/ | Viscosity |
| No. | Composition of alkyd resin | mgKOHg₋₁ | Pa · s at 25° C. |
| 1. | Castor Oil + Phthalic Anhydride + Glycerol | 77.25 | 434.25 |
| 2. | Castor Oil + −63.19%, + | 112.93 | 767.93 |
| | Phthalic anhydride − 30.48% + | | |
| | Glycerol − 6.31 | | |
| 3. | Castor Oil − 61.68%, + | 66.35 | 604.77 |
| | Phthalic Anhydride − 29.75% + Pentaerythritol − | | |
| | 8.55% | | |
| 4. | Castor Oil − 80.56%, | 86.71 | 587.28 |
| | Phthalic Anhydride − 19.43% | | |
| 5. | Castor Oil − 62.80%, | 80.35 | 196.10 |
| | Phthalic Anhydride 30.29% + | | |
| | Glycerol − 6.90% | | |
| U.S. Pat. No. | 10-15 wt. % polyethylene glycol, 20-25 wt. % | 48-61 | 5 PaS |
| 4,051,089 | triglyceride, 18-23 wt. % polyol, 43-48 wt. % | | (5000 cP) |
| | aromatic dicarboxylic acid or anhydride | | |
| U.S. Pat. No. | Short Oil Alkyd 16.5% + Castor oil 29.5% + | 47-53 | |
| 538,228 | Oleic acid 5.0% + Modified Linseed Oil 30%, | | |
| | Carbon Black 19% | | |
| U.S. Pat. No. | 21% wt hexahydrophthalic anhydride, 7% wt of | 5-6.7 | 10 PaS. |
| 6,172,159 | trimellitic anhydride, 16.2% wt 1,4-cyclohexane | | (10,000 cP) |
| | dimethanol, 10.1% wt of trimethylol propane, | | |
| | 40.1% wt polyethylene glycol | | |
| EP | Gum rosin + Fumaric acid + Linseed oil + | 18 | 5-10 PaS |
| 1,739,142 | soybean oil + Pentaerythritol | | (500-1000 cP) |

In the above Table, in comparative examples, the alkyd resins were prepared as a reaction product of dibasic acids, such as acetic anhydride, phthalic anhydride, oleic acid, soybean oil, linseed oil and polyols.

In U.S. Pat. No. 4,051,089: The dibasic acid reacts only with polyol. This results in rapid and uncontrolled formation of cross-linked structure, which has no fluidity. The resultant product is like a gel and has no practical importance. It utilizes expensive raw materials like PEG.

In U.S. Pat. No. 538,228, a two component resin system having hard resin and alkyd resin, is used in the formulation of ink. Alkyd resins are added for better pigment wettability, improved gloss and washability. These are mixed together, not reacted with vegetable oils and solvents to make a varnish which is subsequently used to make ink. Though combination of Hard and alkyd resins provides alkali washability of the ink and reduces the VOC emission from presses, the use of large quantities of low viscosity alkyd resins in these processes increases the setting, drying, and misting times. This also has additional costs and corrosive effects on plant machinery.

In U.S. Pat. No. 6,172,159, expensive raw materials like Trimellitic anhydride are used to produce high viscosity and low acid number alkyd. This increases the cost of production. Further cooking time to produce the resin is also very high.

In EP1739142, viscosity of the product increases with decrease in acid number, as the reaction proceeds forward. The dibasic acid reacts with the monoglycerides (diols, formed by tranesterification reaction of vegetable oils and glycerol). This leads to the formation alkyd resin which consists of straight polymeric chains with minimal cross-linking. These alkyds have considerably low acid numbers in the range of 5-25 mg KOH.

Thus, resins suffers from drawbacks which and their preparation can be traced to low viscosity and low acid number, or low viscosity and high acid number or high acid number and low viscosity.

Contrary to the prior art trend, the applicant has developed novel alkyd resins which achieves very high viscosity and which can be simultaneously controlled alongside a high acid number. This will be clear from the table 2 below:

TABLE 2

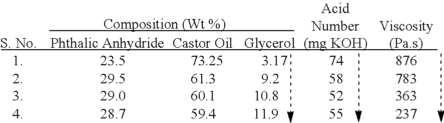

As indicated through arrows in the table, as the concentration of glycerol in the composition increases, the resultant viscosity and acid number of the resin decreases significantly.

The applicant has found that the secondary functionality (OH) in the castor oil enables cross-linking of hydrocarbon chains in the resin composition achievement enabling a higher viscosity than conventional resin formulations along with high acid number. Further, by maintaining the ratio of OH groups from glycerol and OH groups from Castor Oil, the extent of cross linking has been found to increase the molecular mass of the resin composition without causing gelation. This also makes the product containing the resin composition substantially stable on substrates such as paper.

Further, it is cheaper to produce said resins as natural oil polyol (castor oil) is used as key ingredient in place of expensive petroleum based tribasic anhydrides, polyols etc. The alkyd resin has the qualities of both hard resins and alkyd resin in single hybrid resin system.

Another embodiment of the present invention is drawn to a process for preparation provides a preparation of alkyd resin by one step or two step esterification of modified polyols such as glycerol with phthalic anhydride.

In one step esterification, polyol, natural oil polyol, polybasic acid or anhydride and optionally vegetable oil are heated at a temperature 120-160° C. for 1 hour and further heated at a temperature of 210-300° C. for a period of 4-5 hours. In the two step esterification, preparation of mixture of mono, di and tri-esters of polybasic acid or its anhydride with polyol accomplished by heating polyol with polybasic acid or its anhydride at a temperature in the range of 150-180° C. for 30 to 120 minutes. This mixture of mono-, di- and tri-esters is reacted with Natural oil Polyols at temperature of 180 to 300° C. for 2 to 8 hours to produce an alkyd resin. The reaction of mono-, di- and tri-esters of polybasic acids with Natural Oil Polyols enables further crosslinking and attainment of higher viscosity. This reaction is carried out till the acid number of the reaction mixture lies in the range of 50-150 mgKOH/g.

The by-products such as water are removed from the reaction system using one or more water removal techniques known in the art. An example of the water removal techniques includes the use of dehydrants such as Xylene. The Xylene, water and reactant mixture is condensed and separated using, for example a Dean-Stark Separator. The by-products, are either removed continuously or using a batch operation depending upon the process requirements.

Yet another embodiment of this invention is drawn to ink formulation comprising an said alkyd resins comprising of a polyols, natural oil Polyol and polybasic acid and its anhydride and optionally a vegetable oil, wherein the alkyd resin has an acid number in the range of 50-150 mgKOHg⁻¹ and viscosity in the range of 400-5000 PaS. The resin is diluted with drying oils, methyl esters of natural vegetable oil, malenized oils at a temperature of 100 to 200° C. for 5 to 120 minutes get a varnish. The varnish is divided in two parts. One or more colorants are added to one part and one or more additives are added to the other part. These are milled to produce the desired ink formulation.

The term “colorant” as used herein includes oil soluble, natural or synthetic dyes, or pigments that provide the vegetable oil based printing ink formulation with the desired color. This may include, for example, commercially available powdered dyes or pigments, dispersions of such dyes and pigments, and the like.

Any suitable additive capable of imparting the desired characteristics for the ink formulation that is compatible with the vegetable oil-based inks of the present invention can be employed in the ink formulation. Examples of such additives include, for example, preservatives resins, plasticizers, stabilizers, drying agents to improve the quality of the ink. The ink formulation may include 5 to 40 weight percent colorant and 0 to 10 weight percent additives. The ink formulation produced has the desired optical and adhesion properties such as gloss. Further, the ink formulation is substantially stable under the normal temperature and pressure conditions and does not produce misting during the end-product use.

The colorant may include dyes or pigments that are used to impart color to the inks. Examples of the colorant may include natural dyes, synthetic dyes, pigments, and the like. Examples of the natural dyes may include madder, weld, indigo, alkanet and the like. Examples of the synthetic dyes may include anthraquinone dyes, azo dyes, and the like. Examples of the pigments may include Arylide Yellow, Diarylide Yellow, DNA Orange, Pyrazlone Orange, Napthol Red, Lake Red, Lithol Rubine, Azo Magenta, Rhodamine, Pthalocyanine Green, Pthalocyanine Blue, Ultra Marine Violet, Carbon Black etc. The pigment may be a self-dispersing pigment.

The amount of colorant employed in the inks formulation having a viscosity of at least about 10 Pa·S. is the amount necessary to render the ink formulation with desired color. Further, the amount of colorant employed will vary depending upon the color of the dye or pigment in the colorant and the desired drying time of the ink formulation. For example, the more colorant present in the ink formulation, less the time required to dry the ink 5 to 40 weight percent colorant.

An exemplary ink formulation includes:

Alkyd resin: 10-90 wt %

### Vegetable oil: 5-70 wt %

### Colorant: 5-40 wt

Optional ink components (such as preservative additives): 0-10 wt %.

The ink formulation is water reducible and can be cleaned-up with wash solution at slightly elevated pH (of between 8.5-14 and preferably between 9.5-13).

The following examples further describe and demonstrate embodiments within the scope of the present invention. The examples are given solely for the purpose of illustration and not to be construed as limitations of the present invention, as many variations are possible without departing from the spirit and scope of the invention.

### Example 1

### Preparation of Resins

This example illustrates the preparation of alkyd resins by one pot synthesis or two pot synthesis.

One pot synthesis: This includes preparation of monoglycerides/triglycerides and subsequent reaction of the monoglycerides/triglycerides with the polybasic acids in a single process step to produce the alkyd resin composition. The reactants including the polyols, the natural oil polyols with at least one secondary functionality and the polybasic acid are heated in a temperature range about 120° C. to 170° C. for a period of 1 hour. The reaction was further heated at a temperature in range of 200° C. to 300° C. for a period of 4-5 hours. Examples of preparation of alkyd resin using this scheme is given below:
a) 920 g of castor oil, 444 g of phthalic anhydride and 101.2 g glycerol and 146.5 g linseed oil were heated for 1 hour at about 160° C. without water removal. After that reaction mixture was heated at about 210° C. till acid value of the reaction mixture reaches 55 mg KOH/g to produce the alkyd resin. The viscosity of resultant resin is 1206 PaS.
b) 920 g castor oil, 112.2 g pentaerythritol and 444 g phthalic anhydride was heated at about 160° C. for an hour. After that the temperature was increased to about 220° C. till acid value of the reaction mixture reaches about 81 mg per gram KOH. The viscosity of this solution containing the resin product was about 4000 PaS.

Two step synthesis: This involves esterification of polybasic acid or its anhydride with polyol at a temperature in the range of 150-180° C. for 30 minutes to 120 minutes and then reacting the product, mono-, di-, tri-esters with natural oil polyol at a temperature of 180 to 300° C. for 2 to 8 hours. Thereby removing the water by using Xylene and obtaining alkyd resin. The reaction of mono-, di- and tri-esters of polybasic acids with Natural Oil Polyols enables further crosslinking and attainment of higher viscosity. This reaction is carried out till the acid number of the reaction mixture lies in the range of 40-150 mgKOH/g.

Examples of Preparation of alkyd resin using this scheme is given below:

### Example (c)

Reaction of Polyol with Polybasic Acid/Anhydride: 444 g of Phthalic Anhydride was heated with 138 g of glycerol at 170° C. for 60 minutes to produce a mixture mono-, di- and tri-esters of Phthalic Anhydride. The step is done without removal of water.
Reaction of the mixture of mono-, di- and tri-esters with Natural Oil Polyol: This mixture is reacted with 920 g of Castor oil at a temperature of 220° C. accompanied with water removal using Xylene as a dehydrant in Dean-Stark Condenser. The reaction is continued till the said number of the reaction mixture reaches 58 mg KOH/g. The viscosity of the alkyd resin is 783 Pa·S.

The by-product such as water is removed from the reaction system using Xylene and Dean-Stark separator. The by-products are continuously removed or removed using a batch operation depending upon the process parameters.

### Example (d)

Reaction of Polyol with Polybasic Acid/Anhydride: 444 g of Phthalic anhydride was heated with 120 g of Pentaerythritol at 170° C. for 60 minutes to produce a mixture mono-di- and tri-esters of Phthalic Anhydride. The step is done without removal of water.
Reaction of the mixture of mono-, di- and trimesters with Natural Oil Polyol: The mixture is reacted with 920 g of Castor oil at a temperature of 240° C. accompanied with water removal using Xylene as a dehydrant in Dean-Stark Condenser. The reaction is continued till the acid number of the reaction mixture reaches 70 mg KOH/g. The Viscosity of the alkyd resin is 2500 Pa·S.

### Example 2

A number of alkyd resin (A, C, D, F) compositions are prepared by the one-step synthesis method described in Example 1 (a) & (b). In D, the alkyd resin is prepared by reaction of only castor oil with phthalic anhydride. Compositions B, E are prepared by two-step synthesis method described in example 1 (c) & (d) above. The components and amounts thereof are shown in Table 3. The acid number and viscosity (PaS at 25° C.) of the alkyd resin are also given in Table 3.

TABLE 3

| | Alkyd resins | | | | | |
|---|---|---|---|---|---|---|
| Component | A | B | C | D | E | F |
| Castor Oil | 61.25% | 73.25% | 62% | 82% | 62.80% | 34.4% |
| Phthalic | 29.56% | 23.56% | 30% | 18% | 30.29% | 33.23% |
| Anhydride | | | | | | |
| Glycerol | 9.18% | 3.17% | — | — | 6.90% | 10.6% |
| Pentaerythritol | — | — | 7.6% | — | | |
| Linseed Oil | — | — | — | — | — | 21.77% |
| Acid Number/ | 58.3 | 74.42 | 81.2 | 86.71 | 58 | 52.89 |
| mg KOH g⁻¹ | | | | | | |
| Viscosity | 783 | 876 | 4000 | 587 | 1160 | 835 |
| Pa · s at 25° C. | | | | | | |

### Example 3

### Ink Formulation

a) 86.3 g of alkyd resins developed in table 2 was mixed with 13 g alkali refined linseed oil and 0.7 g anti-oxidant to a get a varnish of viscosity of 45 Pa·S. at 89 degree Celsius. 7.5 g of carbon black was mixed with 19 g of the varnish to prepare a first mixture. To this mixture, 1.5 g dispersant and 0.25 drier was mixed. The first mixture was milled on a triple mill to get particle size of less than 5 micron. Another 19 g of the varnish was mixed with 1.5 g microionised polyethylene wax, 1 g clay and 0.35 drier to prepare a second mixture and the second mixture was passed at least twice on a triple roll mill. The first and the second mixtures were together milled for two more passes to get final ink formulation.
b) 5.43 g of alpha blue and 2.06 g violet toner is mixed with 19 g of the varnish to prepare a first mixture. To this mixture, 1.5 g dispersant and 0.25 g drier were mixed. The mixture was milled on a triple role mill to get particle size of less than 5 micron.
   This mixture is let down by a second mixture comprising 1.5 g microionised polyethylene wax, 1 g clay and 0.25 drier in 19 g of the varnish developed.
   The first and the second mixtures were then passed twice on a triple roll mill to get final ink formulation.

### Volatile Emissions:

The pollution mainly comes from the ink and cleaning of the presses which removes the ink that is coated on various surfaces. During applications and clean-up of existing ink, mixture of aliphatic and aromatic solvent is used for cleaning the solvent-based inks. Emissions of volatile organic compounds (VOCs) from these solvents are as much as 47-50%. For example, a typical medium size coldest web plant uses 40,000 kg per year of ink, of which 6000 Kg is lost as emissions. In the present ink formulation, vegetable oil (castor oil)-based alkyd resins are used which produces virtually no emissions during washing of presses. Thus, the solvent emissions during printing as well as cleaning cycles are substantially eliminated.

### Advantages:

The main advantage of the alkyd resin of the invention is that they do not change their physico-chemical properties and no gelation occurs over a long keeping period of storage. The raw material base is cheaper, as natural oil polyols are used in place of expensive petroleum based tribasic anhydrides, polyols etc. Due to high viscosity of the alkyd resins, the amount of resin used in formulation is reduced and cab be used in applications like in inks, paints and coatings. The reactor/plant machinery need not to be changed, and conventional resin plants can be used to produce this resin and subsequently, cost of manufacturing is greatly reduced. This also provides better stability and finish to the paint formulation which was absent in products based on low viscosity resins. The vegetable oil based ink formulation is biodegradable and environment-friendly and easily washable as the resin in the ink becomes a good emulsifying agent in contact with an aqueous alkaline wash solution.

1. An alkyd resin comprising of:
a. a polyol,
b. a polybasic acids or its anhydrides,
c. a natural oil Polyol, and
d. optionally a vegetable oils,
wherein the alkyd resin has an acid number in the range of 50-150 mg KOHg⁻¹, viscosity in the range of 400-5000 PaS.

2. The alkyd resin as claimed in claim 1, wherein the polyol is selected from glycerol, pentaerythritol, neo-pentyl glycol, dipentaerythritol, ethylene glycols, polyethylene glycol.

3. The alkyd resin as claimed in claim 2, wherein the polyol is glycerol.

4. The alkyd resin as claimed in 1, wherein the polybasic acids is selected from phthalic acid, maleic acid, fumaric acid, resin, acids, maleic modified Resin acids, fumaric modified resin acids, adipic acid, succinic acid.

5. The alkyd resin as claimed in 1, wherein the anhydride of polybasic acid is selected from phthalic anhydride, maleic anhydride, trimellitic anhydride.

6. The alkyd resin as claimed in claim 5, wherein the anhydride is phthalic anhydride.

7. The alkyd resin as claimed in claim 1, wherein natural oil polyol is castor oil.

8. The alkyd resin as claimed in claim 1, wherein the vegetable oil is selected from soybean oil, linseed oil, tung oil, sunflower oil, corn oil, canola oil and rapeseed oil.

9. The alkyd resin as claimed in claim 1, wherein the amount of polyol is in the range of 1-10 wt %.

10. The alkyd resin as claimed in claim 8, wherein the amount of polyol is in the range of 4-7 wt %.

11. The alkyd resin as claimed in claim 1, wherein the amount of castor oil is 25-80 wt %.

12. The alkyd resin as claimed in claim 10, wherein preferably the amount of castor oil is 60-82 wt %.

13. The alkyd resin as claimed in claim 1, wherein the amount of polybasic acid/anhydride is in the range of 15-35 wt %.

14. The alkyd resins as claimed in claim 10, wherein the amount of phthalic anhydride is 27-32 wt %.

15. The alkyd resin as claimed in claim 1, wherein the amount of vegetable oil is 0-25 wt %.

16. A process of preparing the alkyd resin as claimed in claim 1, polyol, natural oil polyol, polybasic acid or anhydride and optionally vegetable oil are heated at a temperature 120-160° C. for 1 hour and further heated at a temperature of 210-300° C. for a period of 4-5 hours.

17. A process of preparing the alkyd resin as claimed in claim 1, comprising the steps of:
a. esterifying polybasic acid or its anhydride with polyol at a temperature in the range of 150-180° C. for 30 minutes to 120 minutes,
b. reacting the product of step (a) with natural oil polyol at a temperature of 180 to 300° C. for 2 to 8 hours and c. removing the water by using Xylene and obtaining alkyd resin.

18. An ink formulation comprising an alkyd resin as claimed in claim 1, a vegetable oil, a colorant and optionally additives.
